(19) United States
(12) Patent Application Publication
(10) Pub. No.: US 2004/0015649 A1
(43) Pub. Date: Jan. 22, 2004

(54) Circuit for supplying program/erase voltages in flash memory device

(75) Inventor: Seung Ho Chang, Cheongjoo-Shi (KR)

Correspondence Address: MORGAN LEWIS & BOCKIUS LLP, 1111 PENNSYLVANIA AVENUE NW, WASHINGTON, DC, 20004, US

(73) Assignee: Hynix Semiconductor Inc.

(21) Appl. No.: 10/321,726

(22) Filed: Dec. 18, 2002

(30) Foreign Application Priority Data
Jul. 18, 2002 (KR) 2002-42171

(51) Int. Cl. G06F 12/00

(52) U.S. Cl. 711/103; 365/185.33

(57) ABSTRACT

The present invention relates to a circuit for supplying program/erase voltages in a flash memory. Considering variation in program/erase characteristics generating when program/erase operations are repetitively performed by over given times, voltage of levels that can offset variation in the program/erase characteristics are applied as program/erase voltages upon the program/erase operations, so that the program/erase operations can be normally performed without regard to variation in the program/erase characteristics. Therefore, reliability and life of the circuit can be improved.

### BACKGROUND OF THE INVENTION

1. Field of the Invention

The invention relates generally to a circuit for supplying program/erase voltages in a flash memory device, and more particularly to, a circuit for supplying program/erase voltages in a flash memory device in which program/erase operations can be normally performed without regard to variation of program/erase characteristics due to repetitive erase operation.

2. Description of the Prior Art

Generally, a program operation of the flash memory is performed by means of a FN tunneling or channel hot carrier injection (CHI). An erase operation is performed by means of the FN tunneling. In case that the program operation is performed using CHI and the erase operation is performed using the FN tunneling, the threshold voltage is increased to a target voltage by means of the program operation or the threshold voltage is decreased to the target voltage, initially and normally, by means of the erase operation. However, in the flash memory, if the program operation and the erase operation are repeatedly performed, there occur electrons that are trapped within the floating gate, crystal defects that exist at the interface of silicon and an oxide film, or the like. As the electrons trapped in the floating gate or the crystal defect, etc. are not completely discharged in a bulk by means of the erase operation, the amount of the trapped electrons is increased as the program/erase operations are repeatedly performed. Thus, the threshold voltage after the erase operation is little by little increased than the target voltage or the threshold voltage after the program operation is little by little lowered than the target voltage.

FIG. 1 is a graph showing variation in the threshold voltage depending on program/erase number in a prior art.

Referring to FIG. 1, if the erase operation is performed using the FN tunneling, the threshold voltage is increased over a normal erase threshold voltage and the threshold voltage is also further increased as the erase operation is repeatedly performed, due to electrons remaining in the floating gate or the crystal defects.

On the contrary, if the program operation is performed using CHI of one of the program methods, the degree of program is proportional to Ig (gate current). Also, Ig is determined by Vfg (floating gate voltage), Vd (drain voltage), etc. However, if the program/erase operations are repeatedly performed, the amount of the electrons remaining in the floating gate is little by little increased, which offsets the voltage applied to the control gate. Thus, an effect that Vfg is reduced is generated and the degree of program is lowered little by little. Due to this, if the program operation is continuously performed in a state that Vcg (control gate voltage) is kept constant, the threshold voltage after the program operation is little by little lowered than a target voltage.

Due to this, a circuit is designed to perform a normal sensing operation up to given times (for example, 100000 times), considering variation in the program/erase characteristics due to the erase operation by sufficiently securing a sensing margin between the threshold voltage of a reference cell and the threshold voltage of an operation cell. However, if the program/erase operations are performed over about 10000 times, the threshold voltage is not increased up to the target voltage even though the program operation is performed and the threshold voltage is not lowered down to the target voltage, even though the erase operation is performed.

Also, as the sense amplifier and the reference voltage for reading the program/erase states of the flash memory cell, the threshold voltage of a reference cell and a voltage applied to the flash memory cell are fixed, it is difficult to expect a normal sensing result after the program/erase operations are repetitively performed by given times. This is further a true in case of a multi-level cell in which at least one or more threshold voltages are defined in a single flash memory cell.

As above, in the prior art, the lifetime of the circuit is secured up to a limit without changing the setting in the circuit, by deciding the driving voltage so that the distance between distribution of the program threshold voltage and distribution of the erase threshold voltage can be sufficient considering variation in the threshold voltage in advance. Due to this, there is a problem that the lifetime of the multi-level cell is further shortened since the margin between distributions of the threshold voltages is very bad.

### SUMMARY OF THE INVENTION

The present invention is contrived to solve the above problems and an object of the present invention is to provide a circuit for supplying program/erase voltages in a flash memory capable of improving reliability and lifetime of the circuit, in which considering variation in program/erase characteristics generating when program/erase operations are repetitively performed by over given times, voltages of levels that can offset variation in the program/erase characteristics are applied as program/erase voltages during the program/erase operations so that the program/erase operations can be normally performed without regard to variation in the program/erase characteristics.

In order to accomplish the above object, the circuit for supplying the program/erase voltage according to the present invention, is characterized in that it comprises a program/erase voltage level decision unit for counting the number of erase operations that have been performed, and deciding levels of program/erase voltages supplied to a flash memory cell depending on the total number of the erase operations that have been performed in order to compensate for program/erase characteristics changed by the erase operations, and a program/erase voltage generating unit for generating voltages of various levels and supplying the voltage of the level, among the voltages of the various levels, that can compensate for variation in the program/erase characteristics, as program/erase voltages of the flash memory cell, depending on a signal of the program/erase voltage level decision unit.

In the above, the erase voltage level decision unit comprises an erase operation sensing unit for sensing whether the erase operation of the flash memory cell has been performed, an erase number storage unit for storing the number of the erase operations that have been performed, an erase number 5 counting unit for increasing the erase number stored at the erase number storage unit to again store the increased erase number at the erase number storage unit, depending on the signal of the erase operation sensing unit, and a threshold-voltage characteristic decision unit for deciding the degree of variation in the program/erase characteristics using the erase number of the erase number counting unit to decide the levels of the program/erase voltages.

The erase number storage unit is provided in every sector of the cell and stores the erase number at every sector, and the threshold-voltage characteristic decision unit decides variation in the characteristics of the program/erase operations every sector using the erase number stored at every sector. At this time, the erase number storage unit includes a flash memory cell so that the erase number can be stored even after supply of the power is stopped. Meanwhile, the erase number stored at the erase number storage unit is erased upon the erase operation of the flash memory cell, and the erase number increased in the erase number counting unit is restored upon a program operation of the flash memory cell.

The program/erase voltage generating unit comprises a voltage generating unit for generating a high voltage and a low voltage necessary upon the program/erase operation, and a voltage select unit for generating voltages of various levels using the voltages generated in the voltage generating unit and applying the voltage of a level among the voltages of the various levels, that can compensate for variation in the program/erase characteristics, as the program/erase voltage of the flash memory cell, depending on the signal of the program/erase voltage level decision unit.

### BRIEF DESCRIPTION OF THE DRAWINGS

The aforementioned aspects and other features of the present invention will be explained in the following description, taken in conjunction with the accompanying drawings, wherein:

FIG. 1 is a graph showing variation in the threshold voltage depending on program/erase number in a prior art;

FIG. 2 is a block diagram of a circuit for supplying program/erase voltages in a flash memory according to a preferred embodiment of the present invention; and

FIG. 3 is a graph showing variation in the threshold voltage depending on program/erase number in a prior art.

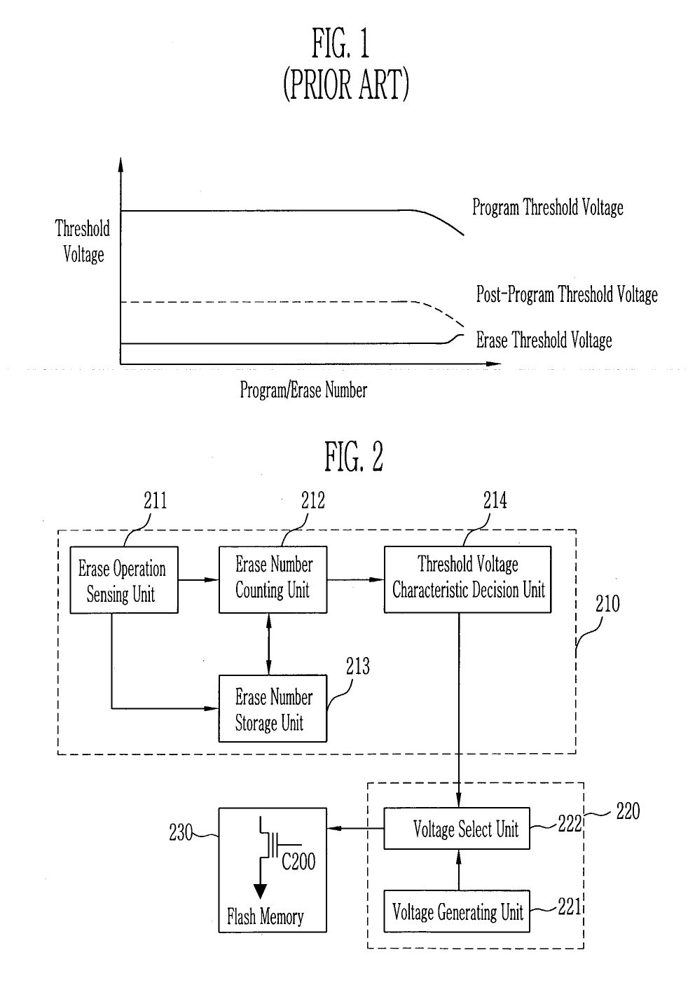

### DETAILED DESCRIPTION OF PREFERRED EMBODIMENTS

The present invention will be described in detail by way of a preferred embodiment with reference to accompanying drawings, in which like reference numerals are used to identify the same or similar parts.

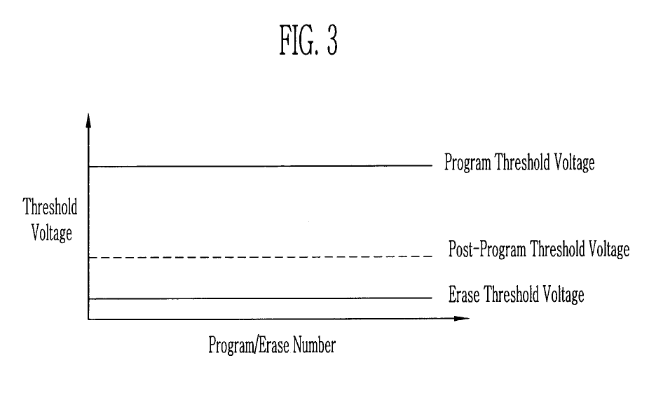

FIG. 2 is a block diagram of a circuit for supplying program/erase voltages in a flash memory according to a preferred embodiment of the present invention.

Referring now to FIG. 2, the circuit for supplying the program/erase voltages in the flash memory of the present invention includes a program/erase voltage level decision unit 210 for determining a level of a program voltage or an erase voltage that will be applied to a flash memory unit 230 having a plurality of flash memory cells C200, (only one cell is shown in the drawing for convenience of explanation), and a program/erase voltage generating unit 220 for generating the program voltage or the erase voltage that is applied to the flash memory unit 230.

In more detail, the program/erase voltage level decision unit 210 serves to count/store the number of all the erase operations that have been performed so far, and determine the levels of program/erase voltages supplied to the flash memory cell depending on the number of the performed erase operations so that the threshold voltage becomes a target voltage during the program/erase operation by compensating for program/erase characteristics changed by the erase operation. On the other hand, the program/erase voltage generating unit 220 serves to generate voltages of various levels necessary for the program or erase operation, and supplies the voltage having a level that can compensate for variation in the program/erase characteristics, among the voltages of various levels, to the flash memory unit 230, depending on the signal of the program/erase voltage level decision unit 210.

In the above, the program/erase voltage level decision unit 210 includes an erase operation sensing unit 211, an erase number storage unit 213, an erase number counting unit 212 and a threshold-voltage characteristic decision unit 214.

The erase operation sensing unit 211 senses whether the erase operation of the flash memory cell C200 has been performed, depending on the erase signal. The erase number storage unit 213 stores all the number of the erase operations that have been performed so far. The erase number storage unit 213 includes a memory means for storing the erase number even when the power is failed. It is preferred that the erase number storage unit 213 is implemented using the flash memory. The number of bits of the memory is decided by the number of the erase operations that have been performed. For example, if the erase number is to be stored until the erase operation becomes 100000 times, the number of bits of the memory is set to 17 bits (2¹⁷). As the erase operation is performed in a sector, the erase number is stored every sector by installing the erase number storage unit 213 every sector.

When the erase operation is performed, the erase number counting unit 212 increases the erase number stored at the erase number storage unit 213, depending on the signal of the erase operation sensing unit 211, and again stores the increased erase number at the erase number storage unit 213. In an actual operation, the erase number stored at the erase number storage unit 213 is erased when the flash memory cell is erased. Next, when a post program is performed, the erase operation is performed for the erase number storage unit 213 by the number increased by one before the previous number.

The threshold-voltage characteristic decision unit 214 decides the levels of the program/erase voltages that will be applied to the flash memory cell C200 during the program/erase operation, under the predetermined conditions, depending on the increased erase number generated in the erase number counting unit 212. For example, states are divided depending on the number of the erase operations that have been performed, for example, like a first state that the erase operation is performed 1000 through 2000 times, a second state that the erase operation is performed 2000 through 3000 times and a third state that the erase operation is performed 3000 through 4000 times. Next, the levels of the program/erase voltages that will be applied to the flash memory cell C200 are differently set every state based on data on variation in the characteristic of the program/erase operation, depending on the number of the performed erase operations. In a state that the levels of the program/erase voltages are set, the threshold-voltage characteristic decision unit 214 predicts variation in the threshold voltage characteristic of the flash memory cell C200 due to variation in the characteristic of the program/erase operation depending on the increased erase number generated in the erase number counting unit 212, and decides the levels of the program/erase voltage that will be applied to the flash memory cell C200 during the program/erase operation.

Meanwhile, the program/erase voltage generating unit 220 includes a voltage generating unit 221 and a voltage select unit 222. The voltage generating unit 221 generates a high voltage and a low voltage necessary for the program/erase operation. Also, the voltage select unit 222 generates voltages of various levels using the voltage generated from the voltage generating unit 221 and selects a voltage of a level among the voltages of the various levels, that can compensate for variation in the program/erase characteristics, depending on the signal of the program/erase voltage level decision unit 210, to apply the selected voltage to the flash memory cell as the program/erase voltage.

Even though the program/erase characteristics of the flash memory cell C200 are varied due to continuous erase operations using the circuit for supplying the program/erase voltages constructed above, the program/erase operations can be performed so that the threshold voltage of the flash memory cell becomes the target voltage without regard to variation in the program/erase characteristics, by applying the voltage of the level that can compensate for variation in the program/erase characteristics during the program/erase operation.

FIG. 3 is a graph showing variation in the threshold voltage depending on program/erase number in a prior art.

As above, as the program/erase operations are performed by applying the voltage of the level that can compensate for variation in the program/erase characteristics to the flash memory cell C200 of the flash memory unit 230 depending on the number of the erase operations that have been performed. The threshold voltage of the program state and the threshold voltage of the erase state can be maintained to have a constant target voltage without regard to the number of the performed erase operations, as shown in FIG. 3.

In the above, the levels of the program/erase voltages that can compensate for variation in the program/erase characteristics could be obtained using equations and experimentally. If the program voltage is increased by the threshold voltage lowered in the CHI program, a constant program characteristic can be obtained. In case of the erase operation using the FN tunneling, the levels of the program/erase voltages for compensation can be obtained through experiment.

Meanwhile, in order to prevent an over-erase problem in case of the flash memory, the post program is performed after the erase operation is performed. In this case, the post program characteristic and the threshold voltage relationship of the reference cells are more considered rather than the erase characteristic. Therefore, in this case, values that can compensate for only two program characteristics of the normal program and the post program are sufficient. Though this method, the level of the compensating voltage depending on the number of the erase operation can be decided.

Meanwhile, in the operation of the chip, all the cells of the chip are not programmed and erased but the program operation is partially performed within the sector. Also, as the erase operation is performed within the entire sector, it is more exact to analyze variation in the program/erase characteristics based on the erase number.

The circuit for supplying the program/erase voltages can be applied not only to the FN tunneling erase/CHI program operation but also to the erase operation and the program operation by means of the FN tunneling.

As mentioned above, according to the present invention, the program/erase voltages are compensated for by the amount of electrons remaining in the floating gate depending on the number of the erase operation. Therefore, the present invention has an advantageous effect that it can improve reliability of the circuit by keeping program/erase characteristics constant. Further, the present invention has an outstanding advantage that it can facilitate designing a multi-level flash memory device by keeping the program/erase characteristics constant.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed is:

1. A circuit for supplying program/erase voltages in a flash memory device, comprising:
a program/erase voltage level decision unit for counting the number of erase operations that have been performed, and deciding levels of program/erase voltages supplied to a flash memory cell depending on the total number of the erase operations that have been performed in order to compensate for program/erase characteristics changed by the erase operations; and
a program/erase voltage generating unit for generating voltages of various levels and supplying the voltage of the level, among the voltages of the various levels, that can compensate for variation in the program/erase characteristics, as program/erase voltages of the flash memory cell, depending on a signal of the program/erase voltage level decision unit.

2. The circuit as claimed in claim 1, wherein the erase voltage level decision unit comprises:
an erase operation sensing unit for sensing whether the erase operation of the flash memory cell has been performed;
an erase number storage unit for storing the number of the erase operations that have been performed;
an erase number counting unit for increasing the ease number stored at the erase number storage unit to again store the increased erase number at the erase number storage unit, depending on the signal of the erase operation sensing unit; and
a threshold-voltage characteristic decision unit for deciding the degree of variation in the program/erase characteristics using the erase number of the erase number counting unit to decide the levels of the program/erase voltages.

3. The circuit as claimed in claim 2, wherein the erase number storage unit includes a flash memory cell so that the erase number can be stored even after the power is failed.

4. The circuit as claimed in claim 2, wherein the erase number storage unit is provided in every sector and stores the erase number at every sector, and wherein the threshold-voltage characteristic decision unit decides variation in the characteristics of the program/erase operations every sector using the erase number stored at every sector.

5. The circuit as claimed in any one of claim 2, wherein the erase number stored at the erase number storage unit is erased during the erase operation of the flash memory cell, and the erase number increased in the erase number counting unit is restored during the program operation of the flash memory cell.

6. The circuit as claimed in claim 1, wherein the program/erase voltage generating unit comprises:,
a voltage generating unit for generating a high voltage and a low voltage necessary upon the program/erase operation; and
a voltage select unit for generating voltages of various levels using the voltages generated in the voltage generating unit and applying the voltage of a level among the voltages of the various levels, that can compensate for variation in the program/erase characteristics, as the program/erase voltage of the flash memory cell, depending on the signal of the program/erase voltage level decision unit.
